(19) United States
(12) Patent Application Publication
(10) Pub. No.: US 2026/0314598 A1
(43) Pub. Date: Oct. 15, 2026

(54) THE USE OF FLORPYRAUXIFEN-BENZYL AS A SOYBEAN HARVEST AID

(71) Applicant: CORTEVA AGRISCIENCE LLC, INDIANAPOLIS, IN (US)

(72) Inventors: ANGELA DA CAS BUNDT, DOM PEDRITO / RIO GRANDE DO SUL (BR); CAIO VITAGLIANO SANTI ROSSI, UBERL+éNDIA, MINAS GERAIS (BR); LUIZ HENRIQUE SAES ZOBIOLE, TOLEDO, PARAN+ü (BR)

(73) Assignee: CORTEVA AGRISCIENCE LLC, INDIANAPOLIS, IN (US)

(21) Appl. No.: 19/100,410

(22) PCT Filed: Aug. 2, 2023
(86) PCT No.: PCT/US2023/071498

§ 371 Date: Jan. 31, 2025

Related U.S. Application Data
(60) Provisional application No. 63/370,505, filed on Aug. 5, 2022.

(51) Int. Cl. A01N 43/40; A01P 21/00

(52) U.S. Cl. CPC A01N 43/40; A01P 21/00

(57) ABSTRACT

A method of using florpyrauxifen-benzyl for pre-harvest soybean desiccation is described.

### BACKGROUND

Soybeans are among the most important crop plants. Improving their growth conditions is thus an ongoing need.

Pre-harvest chemical desiccation is a practice widely adopted by soybean growers worldwide. Early soybean harvesting, aided by chemical desiccation, reduces pest damage, fungal damage, and promotes uniform maturation. Pre-harvest chemical desiccators may be applied from 7 to 15 days before an anticipated harvest date. In Brazil, early planting combined with early harvesting—aided by pre-harvest desiccation—allows the planting of a subsequent crop (corn) during a better rainfall window. Paraquat, diquat, and ammonium-glufosinate are herbicides commonly used for pre-harvest soybean desiccation. However, due its acute and chronic toxicity, paraquat has been banned in many countries. With paraquat prohibited, there are fewer cost-effective pre-harvest soybean desiccation aids for growers to use.

It has now been found that florpyrauxifen-benzyl may be used for pre-harvest soybean desiccation. In one embodiment, applying an effective amount of a florpyrauxifen-benzyl composition 7-15 days pre-harvest to soybean plants or parts thereof or to the locus where the soybean plants grow results in effective desiccation. In certain embodiments a safener may also be applied to soybean plants or parts thereof or to the locus where the soybean plants grow.

### DETAILED DESCRIPTION

### Definitions

As used herein, soybean refers both to the plant itself as well as to its harvested product, such as soybean grains or seeds. As used herein, soybean refers to all species of the genus Glycine, including the wild (for example G. soya, G. Canescens, G. tomentella), as well as the cultivated Glycine max forms. As used herein, soybean also refers to genetically modified soybean plants.

As used herein, the term “genetically modified” refers to plants whose genetic material has been modified by the use of recombinant DNA techniques to include an inserted sequence of DNA that is not native to that plant species' genome or to exhibit a deletion of DNA that was native to that species' genome, wherein the modifications cannot readily be obtained by cross breeding, mutagenesis or natural recombination.

Soybean desiccation in combination with earlier planting can facilitate earlier harvest and increase harvest efficiency. In addition, an early harvest allows the planting of a subsequent crop in a timely manner. Early planting combined with desiccation and early harvest can reduce harvest loss and reduce foreign materials (green stems or weeds) that interfere with harvest machinery.

The yield advantage of early soybean planting has been documented (see, e.g., Hu, M., and P. Wiatrak. 2012. Effect of planting date on soybean growth, yield, and grain quality: review. Agron. J. 104:785-790). However, early planting can lead to increased green stem problems and delayed leaf senescence. The application of desiccants can address these problems, eliminating or reducing green stems and ensuring plant defoliation.

Desiccants may be applied to soybeans when seeds have reached growth stage of from R6.5 to R8 (Boudreaux, J., and J. Griffin. 2011. Application timing of harvest-aid herbicides affects soybean harvest and yield. Weed Technol. 25:38-43). During these growth stages, total pod weight has reached its maximum and seeds will not gain more dry weight.

Various compounds have been employed as soybean harvest aid desiccants including Paraquat (0.125-0.25 lb./acre, 15 day pre-harvest interval (PHI)), Saflufenacil (1-2 fl oz/acre, 3 day PHI), Sodium Chlorate (6 lb./acre, 7-10 day PHI), Dicamba diglycolamine (8-32 oz./acre, 7 day PHI), Carfentrazone-ethyl (1.0-1.5 oz./acre, 3 day PHI), Glufosinate ammonium (14 day PHI).

Surprisingly, florpyrauxifen-benzyl has been discovered to be a soybean desiccant. In one embodiment, applying an effective amount of a florpyrauxifen-benzyl composition 7-15 days pre-harvest to soybean plants or parts thereof or to the locus thereof results in effective desiccation and defoliation. In certain embodiments a safener may also be applied to soybean plants or parts thereof or to the locus thereof. A safener may be applied simultaneously with florpyrauxifen-benzyl or sequentially.

Because florpyrauxifen-benzyl is applied at lower rates (in terms of g a.i./ha) than conventional desiccants (such as paraquat, diquat, and glufosinate) it imposes less of a burden on the environment, minimizing undesired off-target effects. In addition, florpyrauxifen-benzyl has a PHI of only 10 days, giving growers better harvest timing flexibility than, for example, paraquat.

Embodiments of the invention comprise applying florpyrauxifen-benzyl to soybean plants or parts thereof or to the locus where the soybean plants grow at rates of from about 2 to about 25 grams of active ingredient per hectare (g a.i./ha); from about 2 to about 5 g a.i./ha; from about 2 to about 7.5 g a.i./ha; from about 2 to about 10 g a.i./ha; from about 2 to about 15 g a.i./ha; from about 2 to about 20 g a.i./ha; from about 5 to about 7.5 g a.i./ha; from about 5 to about 10 g a.i./ha; from about 5 to about 15 g a.i./ha; from about 5 to about 20 g a.i./ha; from about 5 to about 25 g a.i./ha; from about 7.5 to about 10 g a.i/ha; from about 7.5 to about 15 g a.i./ha; from about 7.5 to about 20 g a.i./ha; from about 7.5 to about 25 g a.i./ha; from about 10 to about 15 g a.i./ha; from about 10 to about 20 g a.i./ha; from about 10 to about 25 g a.i./ha; from about 15 to about 20 g a.i./ha; from about 15 to about 25 g a.i./ha; from about 20 to about 25 g a.i./ha.

Embodiments of the invention comprise applying florpyrauxifen-benzyl to soybean plants or parts thereof or to the locus where the soybean plants grow from about 7 to about 15 days pre-harvest; from about 8 to about 15 days pre-harvest; from about 9 to about 15 days pre-harvest; from about 10 to about 15 days pre-harvest; from about 11 to about 15 days pre-harvest from about 12 to about 15 days pre-harvest; from about 13 to about 15 days pre-harvest; from about 14 to about 15 days pre-harvest.

Embodiments of the invention comprise applying florpyrauxifen-benzyl to soybean plants or parts thereof or to the locus where the soybean plants grow when the soybean plants are at a growth stage of from about R6 to about R8; from about R6 to about R7.8; from about R6 to about R7.6; from about R6 to about R7.4; from about R6 to about R7.2; from about R6 to about R7.0; from about R6 to about R6.8; from about R6 to about R6.6; from about R6 to about R6.4; from about R6 to about R6.2; from about R6.4 to about R8; from about R6.4 to about R7.8; from about R6.4 to about R7.6, from about R6.4 to about R7.4; from about R6.4 to about R7.2; from about R6.4 to about R7.0; from about R6.4 to about R6.8; from about R6.4 to about R6.6.

### EXPERIMENTAL

Field trials were carried out to test the soybean desiccation efficacy of florpyrauxifen-benzyl at 5, 7.5, 10, 15 and 20 g a.i./ha. Soybean plants were sprayed at the R7.2 soybean growth stage.

The comparison standards were diquat at 366 g ai/ha and ammonium-glufosinate at 366 g ae/ha. Herbicides were diluted in water and a single application for each rate (backpack sprayer) was performed employing 100 L/ha of spray solution. The percentage of visual defoliation was assessed at 3, 7 and 10 days after spray application. The significance of treatment effects was evaluated with F-approximate test (α=0.05) and least square means from different treatments were compared with Tukey's test, after adjusting the % defoliation using Abbott's formula (Abbott, W. S., 1925. A method of computing the effectiveness of an insecticide. J. Econ. Entomol. 18:265-267). The results demonstrated that the percentage of defoliation—compared to untreated plants—at the rates of 15 and 20 g ai/ah assessed at 3 DAA, were statistically equivalent to ammonium-glufosinate. At 7 DAA the percentage of defoliation was statistically equivalent to both ammonium-glufosinate and diquat.

TABLE 1
Percentage of defoliation (raw data) on soybean at 3, 7, and 10
days after application (DAA), for herbicide treatments containing
florpyrauxifen-benzyl, ammonium-glufosinate, and diquat.

| | Rate (g | | | | | | |
|---|---|---|---|---|---|---|---|
| Treatment | ai/ha) | 3 DAA | | 7 DAA | | 10 DAA | |
| Florpyrauxifen-benzyl | 5 | 78.8 | B | 89.3 | B | 97.1 | B |
| Florpyrauxifen-benzyl | 7.5 | 80.8 | B | 90.8 | B | 97.9 | B |
| Florpyrauxifen-benzyl | 10 | 81.3 | B | 91.4 | B | 97.9 | B |
| Florpyrauxifen-benzyl | 15 | 82.4 | B | 93.0 | B | 98.6 | B |
| Florpyrauxifen-benzyl | 20 | 84.3 | B | 94.5 | B | 99.1 | B |
| Ammonium glufosinate | 370 | 84.9 | BC | 93.9 | B | 98.1 | B |
| Diquat | 370 | 95.7 | C | 98.9 | A | 99.8 | A |

| | | | | |
|---|---|---|---|---|
| Untreated | 74.4 | A | 83.8.0 | 89.8 |

TABLE 2
Percentage of defoliation (Abbot's formula) on soybean at 3, 7,
and 10 days after application (DAA), for herbicide treatments containing
florpyrauxifen-benzyl, ammonium-glufosinate, and diquat.

| | Rate (g | | | | | | |
|---|---|---|---|---|---|---|---|
| Treatments | ai/ha) | 3 DAA | | 7 DAA | | 10 DAA | |
| Florpyrauxifen-benzyl | 5 | 7.4 | B | 7.8 | B | 9.5 | B |
| Florpyrauxifen-benzyl | 7.5 | 10.0 | B | 9.6 | B | 10.4 | B |
| Florpyrauxifen-benzyl | 10 | 10.7 | B | 10.4 | B | 10.5 | B |
| Florpyrauxifen-benzyl | 15 | 12.3 | B | 12.7 | B | 11.3 | B |
| Florpyrauxifen-benzyl | 20 | 15.3 | B | 14.7 | B | 11.9 | B |
| Ammonium-Glufosinate | 370 | 16.4 | BC | 13.9 | B | 10.8 | B |
| Diquat | 370 | 31.7 | C | 20.5 | A | 12.9 | A |

| | | | | | |
|---|---|---|---|---|---|
| Untreated | 0 | 0.0 | A | 0.0 | 0.0 |

The methods provided herein benefit soybean growers by providing a new harvest-aid for soybean desiccation. Because florpyrauxifen-benzyl is applied at lower rates (in terms of g a.i./ha) than conventional desiccants (such as paraquat, diquat, and glufosinate) it imposes less of a burden on the environment, minimizing undesired off-target effects. In addition, florpyrauxifen-benzyl has a PHI of only 10 days, which gives growers better harvest timing flexibility than, for example, paraquat.

We claim:

1. A method for the desiccation and/or defoliation of soybean plants comprising treating soybean plants or parts thereof or the locus thereof with an effective amount of florpyrauxifen-benzyl.

2. The method of claim 1, wherein the effective amount of the florpyrauxifen-benzyl is from about 2 g a.i/ha to about 25 g a.i.ha.

3. The method of claim 1, wherein the effective amount of the florpyrauxifen benzyl is from about 15 to about 20 g a.i./ha.

4. The method of claim 1, wherein the florpyrauxifen benzyl is applied from 7 to 15 days pre-harvest.

5. The method of claim 1, wherein the florpyrauxifen-benzyl is applied from 10 to 15 days pre-harvest.

6. The method of claim 1, wherein the florpyrauxifen is applied when the soybean growth stage is from R6 to about R8.

7. The method of claim 1, wherein the florpyrauxifen-benzyl is applied when the soybean growth stage is from R6.4 to R7.6.

8. The method of claim 1, wherein the soybean plants are herbicide tolerant.

9. The method of claim 8, wherein the soybean plants are tolerant to herbicides selected from ACC inhibitors, ALS inhibitor herbicides, auxinic herbicides, Photosystem II inhibitors, HPPD inhibitor herbicides, EPSP synthase inhibitor herbicides, or glutamine synthase inhibitor herbicides.
